(19) United States
(12) Patent Application Publication
(10) Pub. No.: US 2003/0076771 A1
(43) Pub. Date: Apr. 24, 2003

(54) Signal processing circuit for optical disc drivers and the related method

(76) Inventors: Jyh-Fong Lin, Taipei City (TW); Yi-Bin Hsieh, Taipei Hsien (TW); Chih-Chang Chien, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,781

(22) Filed: Aug. 16, 2002

(30) Foreign Application Priority Data
Oct. 18, 2001 (TW) 090125839

(51) Int. Cl. G11B 7/005

(52) U.S. Cl. 369/124.11

(57) ABSTRACT

A signal processing circuit and related method for adjusting an input signal and generating a corresponding output signal in an optical disk driver. The signal processing circuit includes an attenuator, an amplifier, a controller, and a waveform adjuster. The attenuator reduces the input signal and generates a first temporary output signal. The amplifier enlarges the input signal and generates a second temporary output signal. The controller selectively enables one of the amplifier or the attenuator according to the first and second temporary signals. The waveform adjuster receives the temporary output signals and generates the output signals.

### BACKGROUND OF THE INVENTION

1. Field of the Invention

The present invention relates to a signal processing circuit for adjusting signal's amplitudes, and more particularly, to a signal processing circuit for switching between an attenuator or an amplifier to adjust the signal's amplitude.

2. Description of the Prior Art

The most important characteristics of the modern information society is that every kind of information and knowledge is transmitted, stored, or manipulated in the form of electrical signals. Information in an electrical signal form can accumulate and be exchanged rapidly, promoting technological development using the strong information manipulating ability of electrical circuits. Until an electrical circuit adjusts this information, we cannot deal correctly with electrical form information, especially in digital form. For example, information stored in an optical disk cannot be transformed correctly to a digital signal for further manipulation or application until read by an optical pickup head, transformed to an electrical signal (via an amplitude-adjusting signal processing circuit), and then processed by properly slicing to a high or a low states.

Please refer to FIG. 1, which is a circuit block diagram illustrating a conventional signal processing circuit 10. The signal processing circuit 10 modulates an input signal 12 and forms a corresponding output signal 26. The output signal 26 will be used later after being properly sliced. The input signal 12 enters from input ends 14A and 14B to the signal processing circuit 10 in a differential signal form. The signal processing circuit 10 always deals with the signals in a differential way. The signal processing circuit 10 comprises an attenuator 16, which can decrease a signal's amplitude, an amplifier 18, which can enlarge a signal's amplitude, a controller 22, and a waveform adjuster circuit 24 (a data slicer for example). The amplifier 18 has a control end 20 for adjusting the amplifier's 18 gain. The controller 22 is basically a signal envelope detector for controlling the amplifier's 18 gain by determining an input signal's amplitude of a corresponding differential pair 22A and 22B. The waveform adjuster circuit 24, functioning like a data slicer circuit, can properly transfer an analog signal into a digital waveform based on a predetermined slice level.

The signal processing circuit 10 works as follows. The input signal 12 enters the signal processing circuit 10 via input ends 14A and 14B. First, an attenuator 16 decreases this input signal. Then the attenuated signal is transmitted via in differential form to an amplifier 18. The amplifier 18 enlarges this signal and outputs this amplified signal as an output signal 26. The output signal 26 is transmitted simultaneously to a waveform adjuster circuit 24 for further signal processing and feedback to the controller 22. The controller 22 adjusts the amplifier's 18 gain via the amplifier's 18 control end 20 according to the signal envelope of the output signal 26. The signal processing circuit 10 can modulate the amplifier's 18 gain and the output signal's 26 amplitude by controller 22. If the output signal's 26 amplitude is still too small, the gain-control circuit 22 will increase amplifier's 18 gain to increase the output signal's 26 amplitude. If the output signal's 26 amplitude is too large, the controller 22 will decrease the amplifier's 18 gain.

The signal processing circuit 10, which can be implemented to optical disc drivers, is used to process electrical signal transformed from an optical signal. This optical signal is read from an optical pickup head. Different optical disc drivers have different gains for the laser generator and the optical pickup head. Each optical disc has its own reflection rate. These differing gains and rates will change an electrical signal's amplitude. For the sake of adjusting different electrical signal's amplitudes, there is the controller 22, embodied in the signal processing circuit 10, to control the amplifier's 18 gain. The controller 22 will guarantee that the output signal's 26 amplitude matches a predetermined value, allowing the waveform adjuster circuit 24 to transform the output signal 26 to a digital-form signal correctly.

However, the conventional signal processing circuit 10 has the following drawbacks. The first one is that the attenuator 16 and the amplifier 18 work simultaneously, that is, they both consume power simultaneously. The second one is that the input signal 12 is processed first via the attenuator 16 and then the amplifier 18, so the amplifier's 18 gain must be large enough to compensate a loss caused by the attenuator 16. Those skilled in the art know that the amplifier 18 has a fixed gain-bandwidth product. That is to say, no one can increase the amplifier's 18 gain without decreasing the amplifier's 18 bandwidth. Therefore, the effective working bandwidth of the signal processing circuit 10 is restricted by the amplifier's 18 bandwidth. This makes customary signal processing circuits unable to handle electrical signals with high frequency or high information density.

### SUMMARY OF INVENTION

It is therefore a primary object of the claimed invention to provide a signal processing circuit for alternately selecting an attenuator or an amplifier to adjust a signal's amplitude to solve the above-mentioned problems.

According to the claimed invention, a signal processing circuit of a compact disk driver for adjusting an input signal and generating a corresponding output signal includes an attenuator, an amplifier, a controller, and a waveform adjuster circuit. The attenuator receives the input signal and attenuates the input signal to generate a first temporary output signal. The amplifier receives the input signal and amplifies the input signal to generate a second temporary output signal. The controller connects to the attenuator and the amplifier for selectively enabling one of the attenuator or the amplifier and disabling the other according to the first temporary output signal and the second temporary output signal. The waveform adjuster receives the first temporary output signal or the second temporary output signal to generate an output signal.

It is an advantage of the claimed invention that a signal processing circuit of a compact disk driver can alternately select an attenuator or an amplifier to adjust a signal's amplitude, guaranteeing a decrease in power consumption.

These and other objects of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a circuit block diagram of a signal processing circuit according to the prior art.

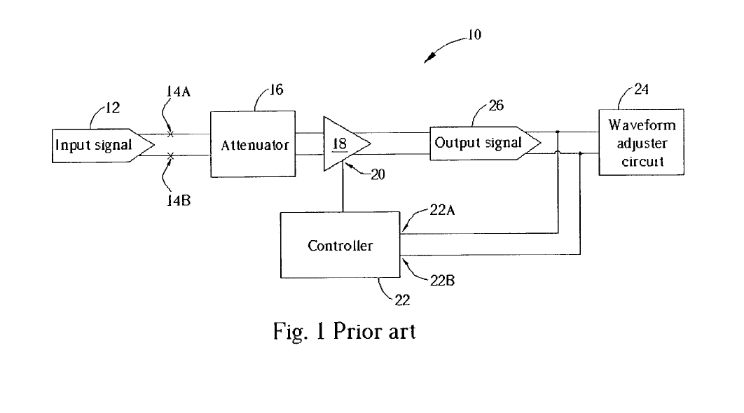

FIG. 2 is a function block diagram of a signal processing circuit according to the present invention.

FIG. 3 is a function block diagram of a waveform adjuster circuit shown in FIG. 2.

### DETAILED DESCRIPTION

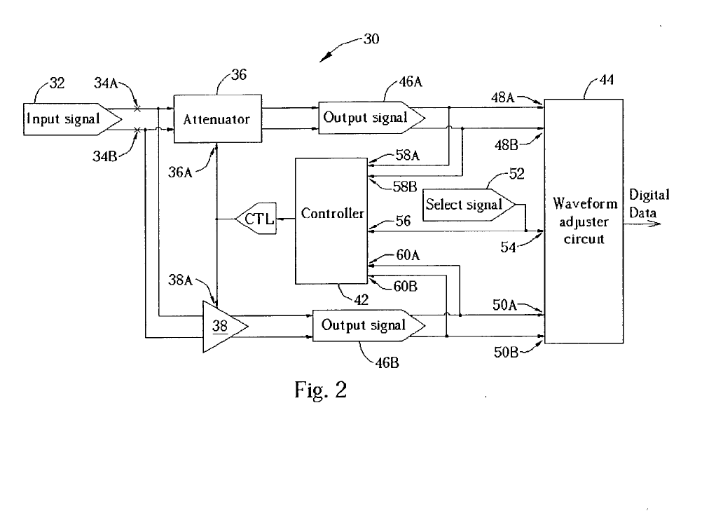

Please refer to FIG. 2, which is a function block diagram illustrating a signal processing circuit 30 according to the present invention. The signal processing circuit 30 can adjust the amplitude of two input signals, which enter from input ends 34A and 34B, to a proper and accepted range. Then a waveform adjuster circuit 44 slices these modulated input signals to digital form signals. The input signal 32 is input to the signal processing circuit 30 in a differential way and all circuit blocks of the signal processing circuit 30 are designed to work with signals in a differential way. The signal processing circuit 30 comprises an attenuator 36, an amplifier 38, a controller 42, and the waveform adjuster circuit 44. The amplifier 38 and the attenuator 36 both connect with the signal processing circuit's 30 differential input ends 34A and 34B and have their own respective control ends 38A and 36A. The amplifier 38 expands the input signal's 32 amplitude to an enlarged output signal 46B. The amplifier's 38 gain can be adjusted by determining the amplifier control end's 38A signal. The attenuator 36 decreases the input signal's 32 amplitude to reduced output signal 46A. The attenuator's 36 gain can be adjusted by determining the attenuator control end's 36A signal. The controller 42 has two differential pairs 58A, 58B and 60A, 60B for receiving respective output signals 46A and 46B. The controller's 42 output end connects respectively with the attenuator's 36 control end 36A and the amplifier's 38 control end 38A. Another input end 56 of the controller 42 receives a select signal 52. The controller 42 measures envelope amplitude of the signals input to its differential pairs 58A, 58B and 60A, 60B, and outputs a corresponding control signal CTL to the attenuator's 36 control end 36A and the amplifier's 38 control end 38A. The select signal 52 commands the controller 42 to measure either the output signal's 46A or the output signal's 46B envelope amplitude. Similar to the controller 42, the waveform adjuster circuit 44 also has two pairs of differential input ends 48A, 48B and 50A, 50B, receiving respectively the attenuated output signal 46A and the enlarged output signal 46B. Another input end 54 of the waveform adjustor circuit 44 receives the select signal 52. The waveform adjuster circuit 44 slices the differential input end's signal to a rectangular waveform digital signal. The select signal 52 commands the waveform adjuster circuit 44 to utilize either output signal 46A or 46B.

An operation model of the signal process circuit 30, according to the present invention, can be described as follows. First, when the input signal 32 enters the signal processing circuit 30, the attenuator 36 attenuates this input signal and generates a corresponding output signal 46A. At the time, the amplifier 38 is off. Thus, no output signal 46B occurs. Next, the select signal 52 commands the controller 42 to input the attenuator's 36 output signals 46A via input ends 58A and 58B. After measuring the envelope amplitude of the output signal 46A, the controller 42 will issue a corresponding CTL signal to the control ends of the attenuator 36 and the amplifier 38. If the measured signal's 46A amplitude is too small, the attenuator 36 stops generating the output signal 46A and instead, the amplifier enlarges the input signal's 32 amplitude (of course, the amplifier 38 changes its own gain, according to controller 42, to adjust the input's 32 amplitude). The select signal 52 also commands the waveform adjuster circuit 44 and the controller 42 to receive output signal 46B rather than 46A. In this way, the waveform adjuster circuit 44 receives a properly enlarged output signal 46B via input ends 50A and 50B and transforms correctly this signal into a digital information form. The controller 42 still monitors the output signal 46B of the amplifier 38. If the controller 42 discovers that the output signal's 46B amplitude is too large (meaning that even the amplifier 38 changing its own gain still cannot adjust properly the input signal's 32 amplitude), the amplifier 38 is disabled. The attenuator 36 is again used to properly adjust the input signal's 32 amplitude and generate the output signal 46A. Simultaneously, the select signal 52 also commands the waveform adjuster circuit 44 to receive output signal 46A from the input ends 48A, 48B rather than 50A, 50B. The controller 42 measures the output signal's 46A amplitude and issues a corresponding CTL signal to attenuator's 36 control end 36A. The attenuator 36 properly decreases the input signal's 32 amplitude.

In conclusion, the signal processing circuit 30, according to the present invention, generates an output signal by dynamically switching between the amplifier 38 and the attenuator 36 according to the signal's amplitude as measured by the controller 42. When the attenuator 36 is generating the output signal, the amplifier 38 is off and not generating any output signal. When the amplifier 38 is generating the output signal, the attenuator 36 is off and not generating any output signal. The select signal 52 commands the waveform adjuster circuit 44 and the controller 42 to receive the output signal 46B while the amplifier 38 is working, and to receive the output signal 46A while the attenuator 36 is working.

In practical situations, the controller 42 can generate the select signal 52 by itself. Another way to generate the select signal 52 is that the controller 42 only transmits the signal's amplitude information to the attenuator 36 or the amplifier 38. These two devices can judge for themselves whether to enable and generate an output signal or not and either the attenuator 36 or the amplifier 38 generates the select signal 52. For example, when the amplifier 38 enables and generates the output signal 46B, the select signal 52 is generated by amplifier 38 and is on a high voltage state. Whereas when attenuator 36 enables (amplifier will disable) and generates the output signal, the select signal 52 is generated by the attenuator 36 and is on a low voltage state. Both the waveform adjuster circuit 44 and the controller 42 can choose to use or monitor the output signals correctly, either 46A or 46B, by determining the select signal 52. The present invention can be applied to an information access circuit of an optical disc driver and is used to correct signal's amplitude bias caused by a different optical disc driver's laser power, a different reflection rate of an optical disc, or a diffident signal gain of an optical pickup head.

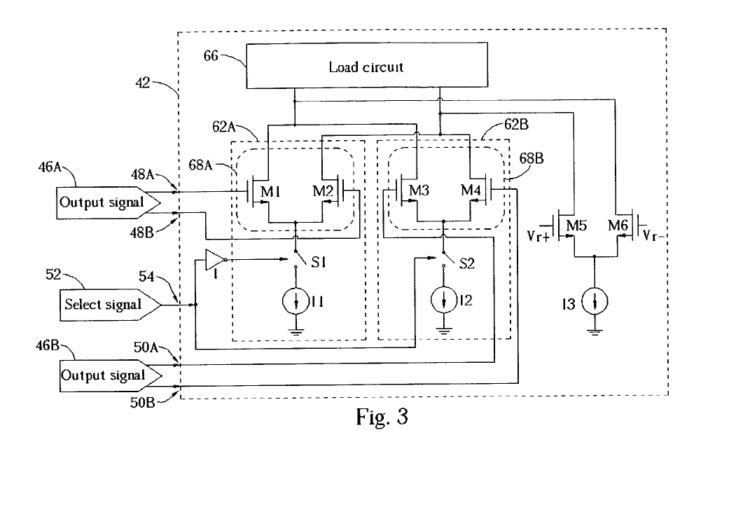

The input stages of the waveform adjuster circuit 44 and the controller 42 are designed in a special way in order to dynamically receive one of the two output signals 46A or 46B. We cite the controller 42 as an example. Please refer to FIG. 3. FIG. 3 is a function block diagram illustrating the controller 42 shown in FIG. 2. As mentioned previously, the controller 42 receives the differential-form output signal 46A of the attenuator 36 via the input ends 48A and 48B, or receives the amplifier's 38 output signal 46B via the input ends 50A and 50B. The controller 42 comprises an input circuit 62 receiving output signals 48A, 48B, 50A, 50B. The input circuit 62 has two input stages, 62A and 62B, incorporated respectively with a corresponding differential pair 68A, 68B. The differential pair 68A comprises transistors M1, M2 whereas the differential pair 68B comprises transistors M3, M4. These two differential pairs 68A, 68B receive respectively differential form output signals 46A and 46B. A load circuit 66 provides these two differential pairs 68A, 68B with load (usually active load) in order to transmit the differential signals 62A, 62B to a next stage that includes a current source I3 and two transistors M5, M6 electrically connected to corresponding voltages Vr+, Vr−. Current sources I1 and I2 provide a bias current to these two differential circuits 68A, 68B. There are also two corresponding switches S1, S2 incorporated between the current sources I1, I2 and the differential pair's 68A, 68B transistors M1, M2, M3, M4. The switches S1, S2 control whether or not the differential pairs 68A, 68B accept working bias current provided by the current sources I1 or I2. For example, if the switch S1 is open, the differential pair 68A has no bias current, will not work, and the input stage 62A will not receive the output signal 46A via the input ends 48A, 48B. The select signal 52 controls whether the switches S1, S2 are open or not. Because the controller 42 receives the output signal 46A or 46B in an alternating way, the select signal 52 also controls switch S1 or S2 in a counter-phase way. The select signal 52 directly controls the switch S2. However, the select signal 52 directly controls the switch S1 via an inverter I.

When the signal processing circuit 30 (FIG. 2) according to the present invention is working, the select signal 52 directs the waveform adjuster circuit 44 and controller 42 to receive output signal 46A or 46B. For example, the select signal 52, in a high voltage state, controls the waveform adjuster circuit 44 to receive output signal 46B. Under this scenario, the select signal 52 closes the switch S2 and the differential pair 68B gets working bias current provided by the current source I2. Input stage 62B, therefore, receives the output signal 46B and transmits the signal 46B to the latter circuit 64 for a necessary manipulation. Simultaneously, the select signal 52 adjusted by the inverter I opens the switch S1. The differential pair 68A cannot get working bias current from current source I1. The input stage 62A stops working and will not receive any output signal 46A. This achieves the goal that the waveform adjuster circuit 44 selectively receives either output signal 46A or 46B.

The waveform adjuster circuit's 44 input circuit's 62 special design not only can achieve the goal of switching between output signals, but also can guarantee that the bandwidth of differential form signal is wide enough. If a switching is incorporated directly on a transmission route of the output signal 46A or 46B, the bandwidth decreases due to an electrical characteristic of switch device itself. In the input circuit 62 according to the present invention, the operation of switching devices is controlled by a bias circuit (that is current source I1, I2) of the input stages 62A, 62B, rather than directly by differential signals on the transmission route. This will guarantee that bandwidth of output signal 46A or 46B will not decrease after being transmitted to the waveform adjuster circuit 44. Of course, since a current source of the input stage does not any bias current because of an open switch, no power is consumed. According to a same design concept, since the controller 42 is controlled by the select signal 52 and alternately receives output signals 46A and 46B, it can also incorporate with another input circuit, like the input circuit 62, order to guarantee that a switch device does not affect a signal's bandwidth. If the input stage of the controller 42 works a way similar to that of the differential input shown in FIG. 3, the controller 42 receives differential input signals via input ends 58A, 58B and 60A, 60B, and outputs a control signal CTL.

Compared with a conventional signal for enabling simultaneously the attenuator 16 and the amplifier 18, the signal processing circuit 30 according to the present invention selectively enables the attenuator 36 or the amplifier 38. One will not operate or generate any output signal while the other is operating and generating an output signal. Thus, the signal processing circuit 30 can save power while operating. Furthermore, the first-attenuating-then-amplifying operation mode for prior art decreases an amplifier's bandwidth resulting in decreases to the output signal's bandwidth because the amplifier needs to provide a larger gain to compensate for the loss of an attenuated input signal. On the contrary, the signal processing circuit 30 only enables either the amplifier or the attenuator at a time. The input signal is not first reduced by an attenuator and then enlarged by an amplifier. Thus, the amplifier's gain need not be too large. The amplifier's increases accordingly and the output signal's bandwidth is not reduced. The present invention also discloses a special design for an input circuit of the waveform adjuster circuit 44 and the controller 42. This special design can decrease power consumption and maintain the signal bandwidth.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A signal processing circuit of a compact disk drive for adjusting an input signal and generating a corresponding output signal, the signal processing circuit comprising:
an attenuator for receiving the input signal and attenuating the input signal to generate a first temporary output signal;
an amplifier for receiving the input signal and amplifying the input signal to generate a second temporary output signal;
a controller connected to the attenuator and the amplifier for selectively enabling one of the attenuator and the amplifier and disabling the other according to the first temporary output signal and the second temporary output signal; and
a waveform adjuster for receiving the first temporary output signal or the second temporary output signal to generate an output signal.

2. The signal processing circuit of claim 1 wherein the controller is capable of controlling the attenuator to adjust an attenuation magnitude imposed on the input signal.

3. The signal processing circuit of claim 1 wherein the controller is capable of controlling the amplifier to adjust an amplification magnitude imposed on the input signal.

4. The signal processing circuit of claim 1 wherein the controller enables/disables the attenuator or the amplifier according to envelopes of the first temporary output signal or the second temporary output signal.

5. The signal processing circuit of claim 1 wherein the waveform adjuster comprises:
a plurality of differential pairs connected to the attenuator and the amplifier for receiving the first temporary output signal of the attenuator and the second temporary output signal of the amplifier; and
a plurality of current sources connected to the attenuator and the amplifier for providing the corresponding differential pair with a bias current;
wherein when the controller selects one of the attenuator or the amplifier to generate the first temporary output signal of the attenuator or the second temporary output signal of the amplifier, the current source of the differential pair corresponding to the enabled attenuator or the enabled amplifier is turned on for providing the bias current.

6. The signal processing circuit of claim 1 wherein the waveform adjuster is a slicer.

7. The signal processing circuit of claim 1 wherein the controller comprises:
a plurality of differential pairs connected to the attenuator and the amplifier for receiving the first temporary output signal of the attenuator and the second temporary output signal of the amplifier; and
a plurality of current sources connected to the attenuator and the amplifier for providing the corresponding differential pair with a bias current;
wherein when the controller selects one of the attenuator or the amplifier to generate the first temporary output signal of the attenuator or the second temporary output signal of the amplifier, the current source of the differential pair corresponding to the enabled attenuator or the enabled amplifier is turned on for providing the bias current.

8. A signal processing method of an optical disk drive for adjusting amplitude of an input signal to generate a corresponding output signal, the signal processing method comprising:
attenuating the input signal for generating a corresponding first temporary signal;
amplifying the input signal for generating a corresponding second temporary signal; and
selecting one of the first temporary signal and the second temporary signal for adjusting a corresponding waveform thereof to generate an output signal.

9. The signal processing method of claim 8 further comprising adjusting an attenuation magnitude imposed on the input signal according to amplitude of the first temporary signal.

10. The signal processing method of claim 8 further comprising adjusting an amplification magnitude imposed on the input signal according to amplitude of the second temporary signal.
